(19) United States
(12) Patent Application Publication
(10) Pub. No.: US 2017/0288897 A1
(43) Pub. Date: Oct. 5, 2017

(54) METHOD AND USER EQUIPMENT FOR PERFORMING MEASUREMENT TO SUPPORT POSITIONING, METHOD AND POSITIONING SERVER FOR SUPPORTING POSITIONING, AND BASE STATION FOR SUPPORTING POSITIONING

(71) Applicant: LG ELECTRONICS INC., Seoul (KR)

(72) Inventors: Hyangsun YOU, Seoul (KR); Hanjun PARK, Seoul (KR); Daesung HWANG, Seoul (KR); Kijun KIM, Seoul (KR); Jonghyun PARK, Seoul (KR); Hyukjin CHAE, Seoul (KR)

(73) Assignee: LG ELECTRONICS INC., Seoul (KR)

(21) Appl. No.: 15/506,975

(22) PCT Filed: Aug. 27, 2015
(86) PCT No.: PCT/KR2015/009007

§ 371 Date: Feb. 27, 2017

Related U.S. Application Data
(60) Provisional application No. 62/043,422, filed on Aug. 29, 2014.

(51) Int. Cl. H04W 64/00; G01S 5/02

(52) U.S. Cl. CPC H04L 12/40; G01S 5/0252; H04W 4/02

(57) ABSTRACT

The present invention provides a UE for performing measurement for positioning, a UE for transmitting a signal for positioning, and a positioning server and a base station for supporting positioning. The measuring UE receives configuration information relating to an uplink reference signal for positioning, receives the uplink reference signal on the basis of the configuration information and transmits information relating to a metric value measured on the basis of the uplink reference signal and information relating to a reception-transmission time difference of the measurement UE.

### TECHNICAL FIELD

The present invention relates to a wireless communication system. More particularly, the present invention provides a method and apparatus for performing measurement for positioning and a method and apparatus supporting positioning.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed.

A general wireless communication system performs data transmission/reception through one downlink (DL) band and through one uplink (UL) band corresponding to the DL band (in case of a frequency division duplex (FDD) mode), or divides a prescribed radio frame into a UL time unit and a DL time unit in the time domain and then performs data transmission/reception through the UL/DL time unit (in case of a time division duplex (TDD) mode). A base station (BS) and a user equipment (UE) transmit and receive data and/or control information scheduled on a prescribed time unit basis, e.g. on a subframe basis. The data is transmitted and received through a data region configured in a UL/DL subframe and the control information is transmitted and received through a control region configured in the UL/DL subframe. To this end, various physical channels carrying radio signals are formed in the UL/DL subframe. In contrast, carrier aggregation technology serves to use a wider UL/DL bandwidth by aggregating a plurality of UL/DL frequency blocks in order to use a broader frequency band so that more signals relative to signals when a single carrier is used can be simultaneously processed.

In addition, a communication environment has evolved into increasing density of nodes accessible by a user at the periphery of the nodes. A node refers to a fixed point capable of transmitting/receiving a radio signal to/from the UE through one or more antennas. A communication system including high-density nodes may provide a better communication service to the UE through cooperation between the nodes.

### DETAILED DESCRIPTION OF THE INVENTION

### Technical Problems

With increase in communication quantity, nodes, and UEs, there is increasing demand for accurate identification of the location of a UE to efficiently and/or accurately provide a communication service to the UE.

The technical objects that can be achieved through the present invention are not limited to what has been particularly described hereinabove and other technical objects not described herein will be more clearly understood by persons skilled in the art from the following detailed description.

### Technical Solutions

To solve the above-described technical problems, the present invention proposes embodiments in which a UE receives UL signals (e.g. sounding reference signals (SRSs) or demodulation reference signals (DM RSs)) transmitted by neighbor UEs and uses the UL signals for location measurement.

In an aspect of the present invention, provided herein is a method of performing measurement for positioning support for a specific user equipment (hereinafter, a target UE) by a user equipment (hereinafter, a measurement UE), including receiving configuration information about an uplink reference signal for positioning; receiving the uplink reference signal based on the configuration information; and transmitting information about a metric value measured based on the uplink reference signal and a reception-transmission time difference of the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

In another aspect of the present invention, provided herein is a user equipment (hereinafter, a measurement UE) for performing measurement for positioning support for a specific user equipment (hereinafter, a target UE), including a radio frequency (RF) unit configured to transmit or receive a signal and a processor configured to control the RF unit. The processor may be configured to control the RF unit to receive configuration information about an uplink reference signal for positioning. The processor may be configured to control the RF unit to receive the uplink reference signal based on the configuration information. The processor may be configured to control the RF unit to transmit information about a metric value measured based on the uplink reference signal and a reception-transmission time difference of the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

In another aspect of the present invention, provided herein is A method of supporting positioning for a specific user equipment (hereinafter, a target UE) by a location server, including transmitting configuration information about an uplink reference signal for positioning to a serving base station of a user equipment for performing measurement (hereinafter, a measurement UE); and receiving information about a metric value measured based on the uplink reference signal and a reception-transmission time difference of the measurement UE from the serving base station of the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by the serving base station of the measurement UE or by the measurement UE, a reference timing, or a transmission power of the reference signal transmitted by the reference signal transmission UE.

In another aspect of the present invention, provided herein is a location server for supporting positioning for a specific user equipment (hereinafter, a target UE), including a radio frequency (RF) unit configured to transmit or receive a signal and a processor configured to control the RF unit. The processor may be configured to control the RF unit to transmit configuration information about an uplink reference signal for positioning to a serving base station of a user equipment for performing measurement (hereinafter, a measurement UE). The processor may be configured to control the RF unit to receive information about a metric value measured based on the uplink reference signal and a reception-transmission time difference of the measurement UE from the serving base station of the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by the serving base station of the measurement UE or by the measurement UE, a reference timing, or a transmission power of the reference signal transmitted by the reference signal transmission UE.

In another aspect of the present invention, provided herein is a method of supporting positioning for a specific user equipment (hereinafter, a target UE) by a base station, including transmitting configuration information about an uplink reference signal for positioning to a user equipment for performing measurement (hereinafter, a measurement UE); and receiving information about a metric value measured based on the uplink reference signal and a reception-transmission time difference of the measurement UE from the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

In another aspect of the present invention, provided herein is a base station for supporting positioning for a specific user equipment (hereinafter, a target UE), including a radio frequency (RF) unit configured to transmit or receive a signal and a processor configured to control the RF unit. The processor may be configured to control the RF unit to transmit configuration information about an uplink reference signal for positioning to a user equipment for performing measurement (hereinafter, a measurement UE). The processor may be configured to control the RF unit to receive information about a metric value measured based on the uplink reference signal and a reception-transmission time difference of the measurement UE from the measurement UE. The configuration information may include at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

In each aspect of the present invention, the information about the measured metric value may include at least a difference between a transmission timing for a serving cell of the measurement UE and a timing at which the measurement UE receives the uplink reference signal, a difference between a reception timing for the serving cell of the measurement UE and the timing at which the measurement UE receives the uplink reference signal, a difference between a transmission or reception timing of a serving base station of the measurement UE and a timing at which the uplink reference signal is transmitted by or received from the reference signal transmission UE, a difference between a reference timing configured by the serving base station of the measurement UE and the timing at which the uplink reference signal is received from the reference signal transmission UE, a difference between a reception timing of the uplink signal transmitted by the reference UE and the timing at which the uplink reference signal is received from the reference signal transmission UE, or a reception power of the uplink reference signal transmitted by the reference signal transmission UE and received by the measurement UE.

In each aspect of the present invention, the target UE may be the measurement UE

In each aspect of the present invention, the target UE may be the reference signal transmission UE.

The above technical solutions are merely some parts of the embodiments of the present invention and various embodiments into which the technical features of the present invention are incorporated can be derived and understood by persons skilled in the art from the following detailed description of the present invention.

### Advantageous Effect

According to an embodiment of the present invention, the location of a UE can be accurately identified.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a downlink (DL) subframe used in a wireless communication system.

FIG. 4 illustrates the structure of a uplink (UL) subframe used in a wireless communication system.

FIG. 5 is a diagram for explaining single-carrier communication and multi-carrier communication.

FIG. 6 illustrates the state of cells in a system supporting the carrier aggregation (CA).

FIG. 7 illustrates positioning reference signals (PRSs) mapped to a resource block.

FIG. 8 illustrates a PRS transmission structure according to parameters of PRS-Info.

FIG. 9 illustrates an information request procedure for UL positioning.

FIG. 10 illustrates a positioning procedure according to an embodiment of the present invention.

FIGS. 11 and 12 illustrate location measurement schemes according to the present invention.

FIG. 13 is a block diagram illustrating elements of a transmitting device 10 and a receiving device 20 for implementing the present invention.

### MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port, a virtual antenna, or an antenna group. A node may be referred to as a point.

A node that transmits a signal is called a transmission point (TP) and a node that receives a signal is called a reception point (RP).

In the present invention, a cell refers to a prescribed geographic region to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between an eNB or node which provides a communication service to the specific cell and a UE. In a LTE/LTE-A based system, The UE may measure DL channel state received from a specific node using cell-specific reference signal(s) (CRS(s)) transmitted on a CRS resource allocated by antenna port(s) of the specific node to the specific node and/or channel state information reference signal(s) (CSI-RS(s)) transmitted on a CSI-RS resource. Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide a service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, coverage of the node may be associated with coverage of “cell” of a radio resource used by the node. Accordingly, the term “cell” may be used to indicate service coverage by the node sometimes, a radio resource at other times, or a range that a signal using a radio resource can reach with valid strength at other times. The “cell” of the radio resource will be described later in more detail.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS (UE-RS), a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signal.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

Hereinafter, OFDM symbol/subcarrier/RE to or for which CRS/DMRS/CSI-RS/SRS/UE-RS is assigned or configured will be referred to as CRS/DMRS/CSI-RS/SRS/UE-RS symbol/carrier/subcarrier/RE. For example, an OFDM symbol to or for which a tracking RS (TRS) is assigned or configured is referred to as a TRS symbol, a subcarrier to or for which the TRS is assigned or configured is referred to as a TRS subcarrier, and an RE to or for which the TRS is assigned or configured is referred to as a TRS RE. In addition, a subframe configured for transmission of the TRS is referred to as a TRS subframe. Moreover, a subframe in which a broadcast signal is transmitted is referred to as a broadcast subframe or a PBCH subframe and a subframe in which a synchronization signal (e.g. PSS and/or SSS) is transmitted is referred to a synchronization signal subframe or a PSS/SSS subframe. OFDM symbol/subcarrier/RE to or for which PSS/SSS is assigned or configured is referred to as PSS/SSS symbol/subcarrier/RE, respectively.

In the present invention, a CRS port, a UE-RS port, a CSI-RS port, and a TRS port refer to an antenna port configured to transmit a CRS, an antenna port configured to transmit a UE-RS, an antenna port configured to transmit a CSI-RS, and an antenna port configured to transmit a TRS, respectively. Antenna ports configured to transmit CRSs may be distinguished from each other by the locations of REs occupied by the CRSs according to CRS ports, antenna ports configured to transmit UE-RSs may be distinguished from each other by the locations of REs occupied by the UE-RSs according to UE-RS ports, and antenna ports configured to transmit CSI-RSs may be distinguished from each other by the locations of REs occupied by the CSI-RSs according to CSI-RS ports. Therefore, the term CRS/UE-RS/CSI-RS/TRS ports may also be used to indicate a pattern of REs occupied by CRSs/UE-RSs/CSI-RSs/TRSs in a predetermined resource region.

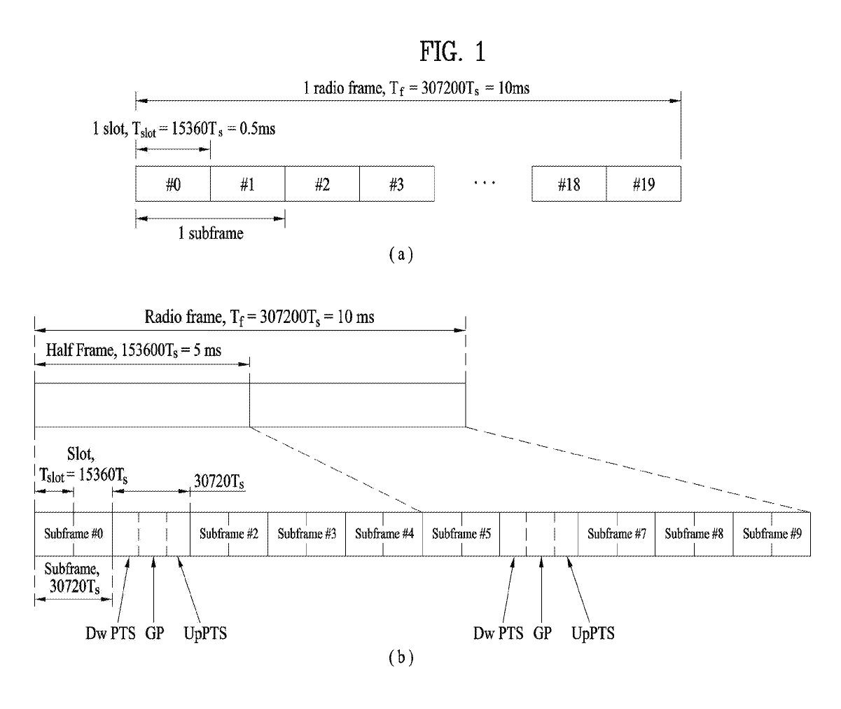

FIG. 1 illustrates the structure of a radio frame used in a wireless communication system.

Specifically, FIG. 1(a) illustrates an exemplary structure of a radio frame which can be used in frequency division multiplexing (FDD) in 3GPP LTE/LTE-A and FIG. 1(b) illustrates an exemplary structure of a radio frame which can be used in time division multiplexing (TDD) in 3GPP LTE/LTE-A. The frame structure of FIG. 1(a) is referred to as frame structure type 1 (FS1) and the frame structure of FIG. 1(b) is referred to as frame structure type 2 (FS2).

Referring to FIG. 1, a 3GPP LTE/LTE-A radio frame is 10 ms (307,200Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| Uplink- | Downlink- | | | | | | | | | | | |
|---|---|---|---|---|---|---|---|---|---|---|---|---|
| downlink | to-Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | Normal cyclic | | | Extended cyclic | | |
|---|---|---|---|---|---|---|
| | prefix in downlink | | | prefix in downlink | | |
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

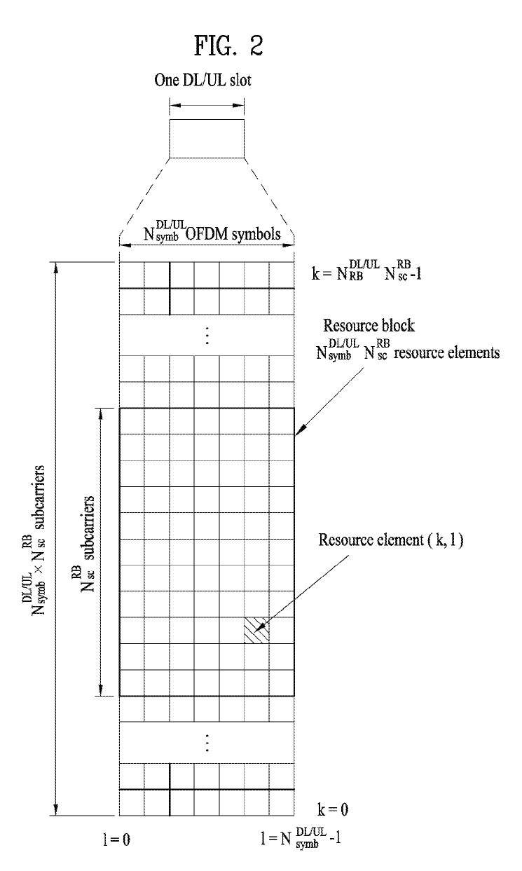

FIG. 2 illustrates the structure of a DL/UL slot structure in a wireless communication system. In particular, FIG. 2 illustrates the structure of a resource grid of a 3GPP LTE/LTE-A system. One resource grid is defined per antenna port.

Referring to FIG. 2, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency f_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}1-1 in the time domain.

Meanwhile, one RB is mapped to one physical resource block (PRB) and one virtual resource block (VRB). A PRB is defined as N^{DL}_{symb} (e.g. 7) consecutive OFDM or SC-FDM symbols in the time domain and N^{RB}_{sc} (e.g. 12) consecutive subcarriers in the frequency domain. Accordingly, one PRB is configured with N^{DL/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

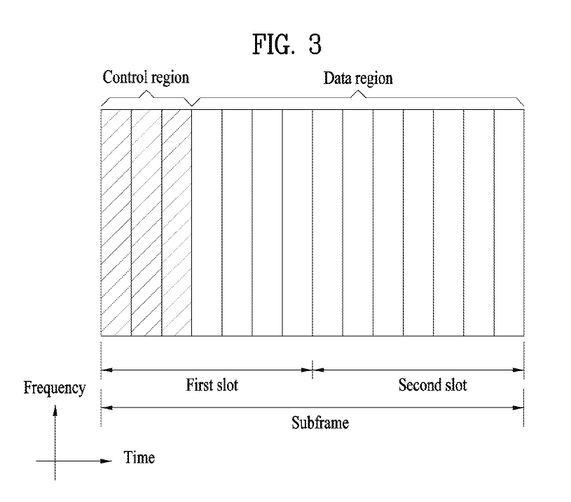

FIG. 3 illustrates the structure of a DL subframe used in a wireless communication system.

Referring to FIG. 3, a DL subframe is divided into a control region and a data region in the time domain. Referring to FIG. 3, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region. Examples of a DL control channel used in 3GPP LTE include a physical control format indicator channel (PCFICH), a physical downlink control channel (PDCCH), a physical hybrid ARQ indicator channel (PHICH), etc. The PCFICH is transmitted in the first OFDM symbol of a subframe and carries information about the number of OFDM symbols available for transmission of a control channel within a subframe. The PHICH carries a HARQ (Hybrid Automatic Repeat Request) ACK/NACK (acknowledgment/negative-acknowledgment) signal as a response to UL transmission.

The control information transmitted through the PDCCH will be referred to as downlink control information (DCI). The DCI includes resource allocation information for a UE or UE group and other control information. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 2C, 3 and 3A are defined for a DL. Combination selected from control information such as a hopping flag, RB allocation, modulation coding scheme (MCS), redundancy version (RV), new data indicator (NDI), transmit power control (TPC), cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, a radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at the bit level.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, one CCE corresponds to nine resource element groups (REGs), and one REG corresponds to four REs. Four QPSK symbols are mapped to each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH). A PDCCH format and the number of DCI bits are determined in accordance with the number of CCEs. The CCEs are numbered and consecutively used. To simplify the decoding process, a PDCCH having a format including n CCEs may be initiated only on CCEs assigned numbers corresponding to multiples of n. The number of CCEs used for transmission of a specific PDCCH is determined by a network or the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

If RRH technology, cross-carrier scheduling technology, etc. are introduced, the amount of PDCCH which should be transmitted by the eNB is gradually increased. However, since a size of a control region within which the PDCCH may be transmitted is the same as before, PDCCH transmission acts as a bottleneck of system throughput. Although channel quality may be improved by the introduction of the aforementioned multi-node system, application of various communication schemes, etc., the introduction of a new control channel is required to apply the legacy communication scheme and the carrier aggregation technology to a multi-node environment. Due to the need, a configuration of a new control channel in a data region (hereinafter, referred to as PDSCH region) not the legacy control region (hereinafter, referred to as PDCCH region) has been discussed. Hereinafter, the new control channel will be referred to as an enhanced PDCCH (hereinafter, referred to as EPDCCH). The EPDCCH may be configured within rear OFDM symbols starting from a configured OFDM symbol, instead of front OFDM symbols of a subframe. The EPDCCH may be configured using continuous frequency resources, or may be configured using discontinuous frequency resources for frequency diversity. By using the EPDCCH, control information per node may be transmitted to a UE, and a problem that a legacy PDCCH region may not be sufficient may be solved. For reference, the PDCCH may be transmitted through the same antenna port(s) as that(those) configured for transmission of a CRS, and a UE configured to decode the PDCCH may demodulate or decode the PDCCH by using the CRS. Unlike the PDCCH transmitted based on the CRS, the EPDCCH is transmitted based on the demodulation RS (hereinafter, DMRS). Accordingly, the UE decodes/demodulates the PDCCH based on the CRS and decodes/demodulates the EPDCCH based on the DMRS. The DMRS associated with EPDCCH is transmitted on the same antenna port pε{107,108,109,110} as the associated EPDCCH physical resource, is present for EPDCCH demodulation only if the EPDCCH transmission is associated with the corresponding antenna port, and is transmitted only on the PRB(s) upon which the corresponding EPDCCH is mapped.

A certain number of REs are used on each RB pair for transmission of the DMRS for demodulation of the EPDCCH regardless of the UE or cell if the type of EPDCCH and the number of layers are the same as in the case of the UE-RS for demodulation of the PDSCH. Hereinafter, a PDCCH and an EPDCCH are simply referred to as PDCCHs except in cases specific to the EPDCCH. The present invention may be applied to an EPDCCH, a PUSCH, and a PDSCH and/or a PUSCH scheduled by the EPDCCH as well as to a PDCCH, a PUCCH, and a PDSCH and/or a PUSCH scheduled by the PDCCH.

In a 3GPP LTE/LTE-A system, a CCE set in which a PDCCH can be located for each UE is defined. A CCE set in which the UE can detect a PDCCH thereof is referred to as a PDCCH search space or simply as a search space (SS). An individual resource on which the PDCCH can be transmitted in the SS is called a PDCCH candidate. A set of PDCCH candidates that the UE is to monitor is defined as the SS. SSs for respective PDCCH formats may have different sizes and a dedicated SS and a common SS are defined. The dedicated SS is a UE-specific SS (USS) and is configured for each individual UE. The common SS (CSS) is configured for a plurality of UEs.

An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) “A” and information about data transmitted using a radio resource “B” (e.g. frequency location) and using transport format information “C” (e.g. transmission block size, modulation scheme, coding information, etc.) is transmitted in a specific DL subframe. Then, the UE monitors the PDCCH using RNTI information thereof. The UE having the RNTI “A” receives the PDCCH and receives the PDSCH indicated by “B” and “C” through information of the received PDCCH.

Generally, a DCI format capable of being transmitted to a UE differs according to a transmission mode (TM) configured for the UE. In other words, for the UE configured for a specific TM, only some DCI format(s) corresponding to the specific TM rather than all DCI formats may be used. For example, the UE is semi-statically configured by higher layers so as to receive PDSCH data signaled through a PDCCH according to one of a plurality of predefined TMs. To maintain operation load of the UE according to blind decoding attempt at a predetermined level or less, all DCI formats are not always simultaneously searched by the U.

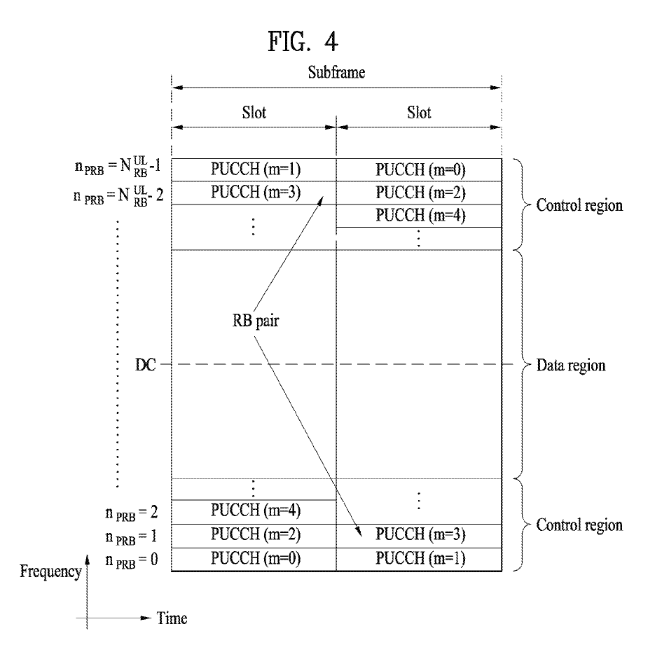

FIG. 4 illustrates the structure of a UL subframe used in a wireless communication system.

Referring to FIG. 4, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. CSI may include channel quality information (CQI), a precoding matrix indicator (PMI), a precoding type indicator, and/or a rank indicator (RI). In the CSI, multiple input multiple output (MIMO)-related feedback information includes the RI and the PMI. The RI indicates the number of streams or the number of layers that the UE can receive through the same time-frequency resource. The PMI is a value reflecting a space characteristic of a channel, indicating an index of a precoding matrix preferred by a UE for DL signal transmission based on a metric such as an SINR. The CQI is a value of channel strength, indicating a received SINR that can be obtained by the UE generally when an eNB uses the PMI.

A sounding reference signal (SRS) may be transmitted in a UL subframe. In the UL subframe configured for SRS transmission, the SRS is transmitted on an SC-FDMA symbol located last on the time axis. SRSs of multiple UEs, transmitted on the last SC-FDMA symbol of the same subframe may be distinguished according to a frequency location/sequence. The SRSs may be periodically or aperiodically transmitted.

Periodic transmission of the SRS is configured by a cell-specific SRS parameter and a UE-specific SRS parameter. The cell-specific SRS parameter (in other words, cell-specific SRS configuration) and the UE-specific SRS parameter (in other words, UE-specific SRS configuration) are transmitted to the UE through higher layer (e.g. RRC) signaling. The cell-specific SRS parameter indicates subframes occupied for SRS transmission in a cell to a UE and the UE-specific SRS parameter indicates subframes that a corresponding UE is to actually use among the subframes occupied for SRS transmission. The UE periodically transmits the SRS through a specific symbol (e.g. last symbol) designated as the UE-specific SRS parameter. Specifically, the cell-specific SRS parameter includes srs-BandwidthConfig and srs-SubframeConfig. srs-BandwidthConfig indicates information about a frequency band in which the SRS can be transmitted and srs-SubframeConfig indicates information (e.g. transmission period/offset) about subframes in which the SRS can be transmitted. The subframes in which the SRS can be transmitted in a cell are periodically configured in a frame.

The UE-specific SRS parameter includes srs-Bandwidth, srs-HoppingBandwidth, freqDomainPosition, and srs-ConfigIndex. srs-Bandwidth indicates a value used to configure a frequency band in which a corresponding UE should transmit the SRS. srs-HoppingBandwidth indicates a value used to configure frequency hopping of the SRS. FreqDomainPosition indicates a value used to determine a frequency position at which the SRS is transmitted. srs-ConfigIndex indicates a value (e.g. a transmission period/offset) used to configure a subframe in which a corresponding UE should transmit the SRS.

A subframe in which an aperiodic SRS can be transmitted may be periodically located within subframes indicated by a cell-specific parameter. For example, the subframe in which the aperiodic SRS can be transmitted may be given by an SRS transmission period/offset T_{offset}. The aperiodic SRS is indicated by a UL grant PDCCH and the UE transmits the SRS in an aperiodic SRS transmittable subframe which is nearest an aperiodic SRS request received subframe after four subframes starting from the aperiodic SRS request received subframe.

Meanwhile, in order to protect SRS transmission in a subframe/band occupied through the cell-specific SRS parameter, the UE does not transmit a PUSCH/PUCCH on the last symbol of a subframe irrespective of whether the SRS is actually transmitted when the PUSCH/PUCCH is transmitted in the corresponding subframe/band. To this end, the PUSCH/PUCCH is rate-matched or punctured on a symbol for SRS transmission (i.e. last symbol).

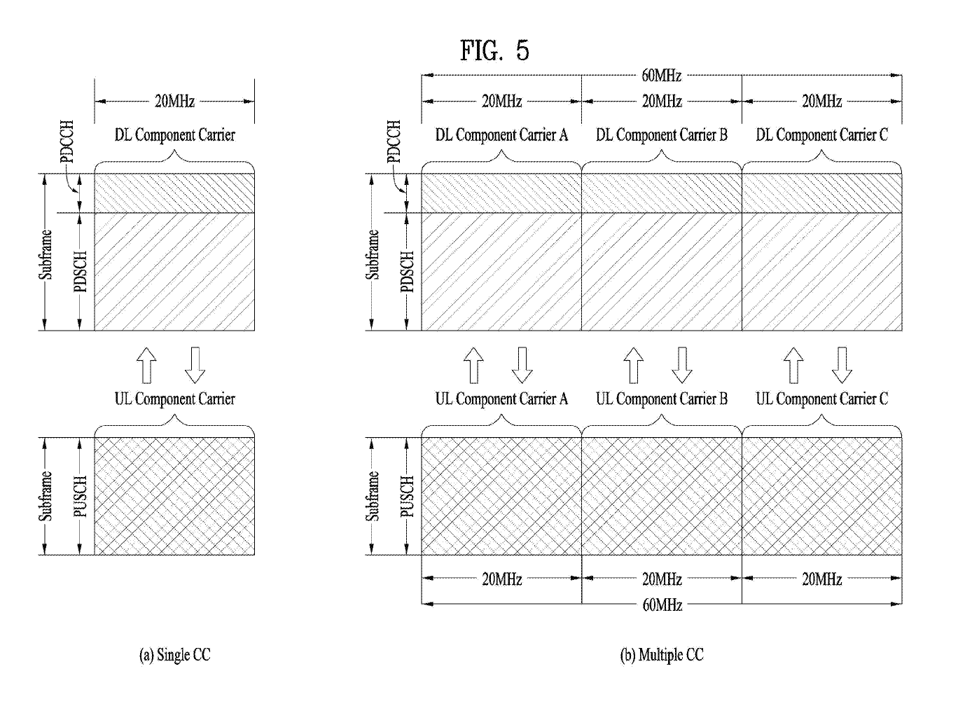

FIG. 5 is a diagram for explaining single-carrier communication and multi-carrier communication. Specially, FIG. 5(a) illustrates a subframe structure of a single carrier and FIG. 5(b) illustrates a subframe structure of multiple carriers.

Referring to FIG. 5(a), a general wireless communication system transmits/receives data through one downlink (DL) band and through one uplink (UL) band corresponding to the DL band (in the case of frequency division duplex (FDD) mode), or divides a prescribed radio frame into a UL time unit and a DL time unit in the time domain and transmits/receives data through the UL/DL time unit (in the case of time division duplex (TDD) mode). Recently, to use a wider frequency band in recent wireless communication systems, introduction of carrier aggregation (or BW aggregation) technology that uses a wider UL/DL BW by aggregating a plurality of UL/DL frequency blocks has been discussed. A carrier aggregation (CA) is different from an orthogonal frequency division multiplexing (OFDM) system in that DL or UL communication is performed using a plurality of carrier frequencies, whereas the OFDM system carries a base frequency band divided into a plurality of orthogonal subcarriers on a single carrier frequency to perform DL or UL communication. Hereinbelow, each of carriers aggregated by carrier aggregation will be referred to as a component carrier (CC). Referring to FIG. 5(b), three 20 MHz CCs in each of UL and DL are aggregated to support a BW of 60 MHz. The CCs may be contiguous or non-contiguous in the frequency domain. Although FIG. 5(b) illustrates that a BW of UL CC and a BW of DL CC are the same and are symmetrical, a BW of each component carrier may be defined independently. In addition, asymmetric carrier aggregation where the number of UL CCs is different from the number of DL CCs may be configured. A DL/UL CC for a specific UE may be referred to as a serving UL/DL CC configured at the specific UE.

In the meantime, the 3GPP LTE-A system uses a concept of cell to manage radio resources. The cell is defined by combination of downlink resources and uplink resources, that is, combination of DL CC and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

The eNB may activate all or some of the serving cells configured in the UE or deactivate some of the serving cells for communication with the UE. The eNB may change the activated/deactivated cell, and may change the number of cells which is/are activated or deactivated. If the eNB allocates available cells to the UE cell-specifically or UE-specifically, at least one of the allocated cells is not deactivated unless cell allocation to the UE is fully reconfigured or unless the UE performs handover. Such a cell which is not deactivated unless CC allocation to the UE is full reconfigured will be referred to as Pcell, and a cell which may be activated/deactivated freely by the eNB will be referred to as Scell. The Pcell and the Scell may be identified from each other on the basis of the control information. For example, specific control information may be set to be transmitted and received through a specific cell only. This specific cell may be referred to as the Pcell, and the other cell(s) may be referred to as Scell(s).

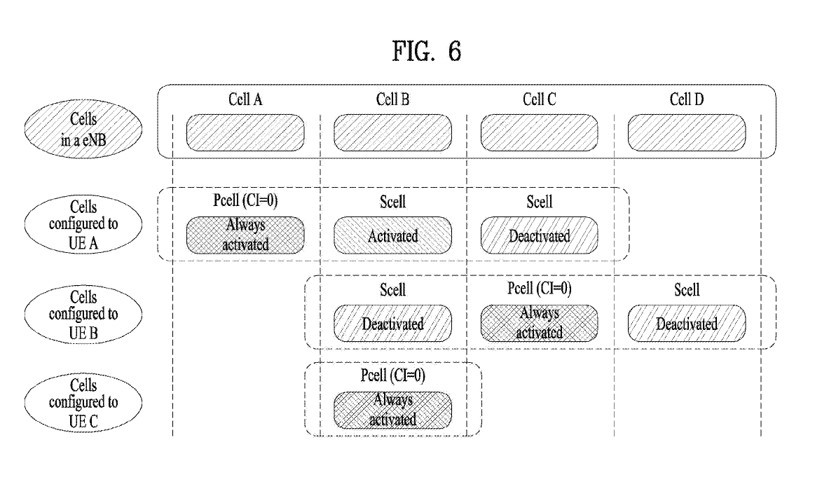

FIG. 6 illustrates the state of cells in a system supporting CA.

In FIG. 6, a configured cell refers to a cell in which CA is performed for a UE based on measurement report from another eNB or UE among cells of an eNB and is configured for each UE. The configured cell for the UE may be a serving cell in terms of the UE. The configured cell for the UE, i.e. the serving cell, prereserves resources for ACK/NACK transmission for PDSCH transmission. An activated cell refers to a cell configured to be actually used for PDSCH/PUSCH transmission among configured cells for the UE and CSI reporting and SRS transmission for PDSCH/PUSCH transmission are performed on the activated cell. A deactivated cell refers to a cell configured not to be used for PDSCH/PUSCH transmission by the command of an eNB or the operation of a timer and CSI reporting and SRS transmission are stopped on the deactivated cell. For reference, in FIG. 6, CI denotes a serving cell index and CI=0 is applied to Pcell. The serving cell index is a short ID used to identify the serving cell and, for example, any one of integers from 0 to ‘maximum number of carrier frequencies which can be configured for the UE at a time minus 1’ may be allocated to one serving cell as the serving cell index. That is, the serving cell index may be a logical index used to identify a specific serving cell among cells allocated to the UE rather than a physical index used to identify a specific carrier frequency among all carrier frequencies.

As described above, the term “cell” used in carrier aggregation is differentiated from the term “cell” indicating a certain geographical area where a communication service is provided by one eNB or one antenna group.

Generally, in a cellular communication system, various methods are used in order for a network to acquire location information of the UE. Typically, in an LTE system, information regarding PRB transmission of eNBs is configured using a higher layer signal for the UE. The UE measures PRSs transmitted by neighbor cells thereof and transmits a reference signal time difference (RSTD) between a reception timing of a PRS transmitted by a reference eNB and a reception timing of a PRS transmitted by a neighbor eNB to an eNB or the network.

The RSTD is a relative timing difference between a neighbor cell j and a reference cell i, defined as ‘T_{SubframeRxj}−T_{SubframeRxi}’. Herein, T_{SubframeRxj} is a time when the UE receives the start of one subframe from the cell j and T_{SubframeRxi} is a time when the UE receives the start of one subframe from a cell that is closest to the subframe received from cell j. A reference point for an observed subframe time difference is an antenna connector of the UE. The UE may use a UE reception (Rx)-transmission (Tx) time difference to calculate the RSTD. The UE Rx-Tx time difference is defined as ‘T_{UE-RX}−T_{UE-TX}’. Herein, T_{UE-RX} is a UE received timing of a DL radio frame #i from a serving cell, defined by the first detected path in time and T_{UE-TX} is a UE transmitted timing of a UL radio frame #i. A reference point for measuring the UE Rx-Tx time difference is the antenna connector of the UE.

The network calculates the location of the UE using the RSTD and other information. Such a positioning scheme for the UE is called observed time difference of arrival (OTDOA) based positioning. OTDOA based positioning will now be described in more detail.

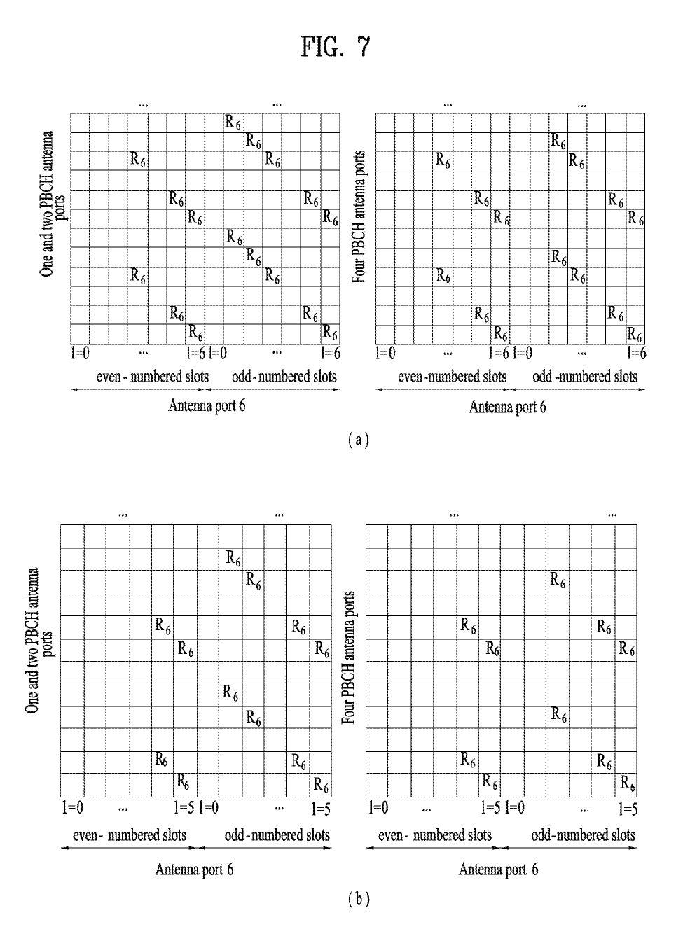

FIG. 7 illustrates positioning reference signals (PRSs) mapped to a resource block.

A PRS has a transmission opportunity, i.e. a positioning occasion, at a period of 160, 320, 640, or 1280 ms. The PRS may be transmitted during N_{PRS} consecutive DL subframes at the positioning occasion. Herein, N_{PRS} may be 1, 2, 4, or 6. Although the PRS is substantially transmitted at the positioning occasion, the PRS may be muted at the positioning occasion, for inter-cell interference coordination. In other words, zero transmission power may be allocated to REs to which the PRS is mapped at the positioning occasion, so that the PRS may be transmitted with zero transmission power on PRS REs. Information about PRS muting is provided to the UE as prs-MutingInfo. The transmission bandwidth of the PRS may be independently configured differently from the system bandwidth of a serving eNB. For example, the transmission bandwidth of the PRS may be 6, 15, 25, 50, 75, or 100 RBs. The transmission sequences of the PRS are generated by initializing a pseudo-random sequence generator on every OFDM symbol using a function of a slot index, an OFDM symbol index, a cyclic prefix (CP), and a cell ID. The generated PRS sequences are mapped to REs as illustrated in FIG. 7(a) in a subframe having a normal CP and to REs as illustrated in FIG. 7(b) in a subframe of an extended CP. The locations of REs to which the PRS is mapped may be shifted on the frequency axis and a frequency shift value of the PRS is determined by a cell ID. For reference, FIGS. 7(a) and 7(b) illustrate the locations of PRS REs having a frequency shift of 0.

For PRS measurement, the UE receives configuration information about the list of PRSs that the UE should discover from a location management server (e.g. an enhanced serving mobile location center (E-SMLC) or a secure user plane location (SUPL) platform) of a network. The configuration information includes PRS configuration information of a reference cell and PRS configuration information of neighbor cells. The configuration information of each PRS includes a positioning occasion occurrence period, an offset, the number of consecutive DL subframes constituting one positioning occasion, a cell ID used to generate PRS sequences, a CP type, and the number of CRS antenna ports considered during PRS mapping. The PRS configuration information of neighbor cells includes slot offsets and subframe offsets of the neighbor cells and the reference cell, an expected RSTD, and a degree of uncertainty of the expected RSTD. The PRS configuration information of neighbor cells may cause the UE to determine at which timing and to which degree of a time window the UE should discover corresponding PRSs in order for the UE to detect PRSs transmitted by the neighbor cells.

In this way, the LTE system has introduced an OTDOA scheme in which eNBs transmit PRSs and the UE estimates an RSTD from the PRSs through a time difference of arrival (TDOA) scheme and transmits the estimated RSTD to the network. In the LTE system, an LTE positioning protocol (LPP) has been defined to support the OTDOA scheme. The LPP is terminated between a target device and a positioning server. The target device may be a UE in a control plane or an SUPL enabled terminal (SET) in a user plane. The positioning server may be an E-SMLC in the control plane or an SUPL location platform (SLP) in the user plane. The LPP informs the UE of OTDOA-ProvideAssistanceData shown in the following configuration as an information element (IE).

TABLE 3
-- ASN1START
OTDOA-ProvideAssistanceData ::= SEQUENCE {

| | | | |
|---|---|---|---|
| otdoa-ReferenceCellInfo | OTDOA-ReferenceCellInfo | OPTIONAL, | -- |

Need ON

| | | | |
|---|---|---|---|
| otdoa-NeighbourCellInfo | OTDOA-NeighbourCellInfoList | OPTIONAL, | -- |

Need ON

| | | |
|---|---|---|
| otdoa-Error | OTDOA-Error | OPTIONAL, |

-- Need ON
...

}
-- ASN1STOP

Herein, OTDOA-ReferenceCellInfo represents information about a reference cell for measuring an RSTD and includes the following information.

TABLE 4
-- ASN1START
OTDOA-ReferenceCellInfo ::= SEQUENCE {

| physCellId | INTEGER (0..503), | | |
|---|---|---|---|
| cellGlobalId | ECGI | OPTIONAL, | -- |

Need ON

| | | | |
|---|---|---|---|
| earfcnRef | ARFCN-ValueEUTRA | OPTIONAL, | -- |

Cond NotSameAsServ0

| | |
|---|---|
| antennaPortConfig | ENUMERATED {ports1-or-2, ports4, ... } |

OPTIONAL,

-- Cond NotSameAsServ1

| | |
|---|---|
| cpLength | ENUMERATED { normal, extended, ... }, |

| | | | |
|---|---|---|---|
| prsInfo | PRS-Info | OPTIONAL, | -- |

Cond PRS
...,

| | | |
|---|---|---|
| [[ earfcnRef-v9a0 ARFCN-ValueEUTRA-v9a0 | OPTIONAL | -- |

Cond NotSameAsServ2
]]
}
-- ASN1STOP

In Table 3, OTDOA-NeighbourCellInfo represents target cells (e.g. eNBs or TPs) for RSTD measurement.

Referring to Table 4, OTDOA-NeighbourCellInfo may include information about a maximum of 24 neighbor cells per frequency layer with respect to a maximum of 3 frequency layers. That is, information about a total of 72 (=3*24) cells may be indicated to the UE using OTDOA-NeighbourCellInfo.

TABLE 5
-- ASN1START
OTDOA-NeighbourCellInfoList ::= SEQUENCE (SIZE (1..maxFreqLayers)) OF OTDOA-
NeighbourFreqInfo
OTDOA-NeighbourFreqInfo ::= SEQUENCE (SIZE (1..24)) OF OTDOA-
NeighbourCellInfoElement
OTDOA-NeighbourCellInfoElement ::= SEQUENCE {

| physCellId | INTEGER (0..503), | | |
|---|---|---|---|
| cellGlobalId | ECGI | OPTIONAL, | -- |

Need ON

| | | | |
|---|---|---|---|
| earfcn | ARFCN-ValueEUTRA | OPTIONAL, | -- |

Cond NotSameAsRef0

| | |
|---|---|
| cpLength | ENUMERATED {normal, extended, ...} |

| | |
|---|---|
| OPTIONAL, | -- |

Cond NotSameAsRef1

| | | | | |
|---|---|---|---|---|
| prsInfo | PRS-Info | OPTIONAL, | -- | Cond |

NotSameAsRef2

| | |
|---|---|
| antennaPortConfig | ENUMERATED {ports-1-or-2, ports-4, ...} |

| | |
|---|---|
| OPTIONAL, | -- |

Cond NotsameAsRef3

| | | | |
|---|---|---|---|
| slotNumberOffset | INTEGER (0..19)OPTIONAL, | -- | Cond |

NotSameAsRef4

| | | | |
|---|---|---|---|
| prs-SubframeOffset | INTEGER (0..1279) | OPTIONAL, | -- |

Cond InterFreq

| | |
|---|---|
| expectedRSTD | INTEGER (0..16383), |
| expectedRSTD-Uncertainty | INTEGER (0..1023), |

| ..., | | | |
|---|---|---|---|
| [[ earfcn-v9a0 | ARFCN-ValueEUTRA-v9a0 OPTIONAL | -- | Cond |

NotSameAsRef5

]]

}
maxFreqLayers INTEGER ::= 3
-- ASN1STOP

Herein, PRS-Info, which is an IE included in OTDOA-ReferenceCellInfo and OTDOA-NeighbourCellInfo, contains PRS information. Specifically, PRS bandwidth, PRS configuration index I_{PRS}, the number of consecutive DL subframes N_{PRS}, and PRS muting information may be included in PRS-Info as follows.

TABLE 6
-- ASN1START
PRS-Info ::= SEQUENCE {

| prs-Bandwidth | ENUMERATED { n6, n15, n25, n50, |
|---|---|
| | n75, n100, ... }, |
| prs-ConfigurationIndex | INTEGER (0..4095), |
| numDL-Frames | ENUMERATED {sf-1, sf-2, sf-4, sf-6, |
| | ...}, |
| ..., | |
| prs-MutingInfo-r9 | CHOICE { |

| | |
|---|---|
| po2-r9 | BIT STRING (SIZE(2)), |
| po4-r9 | BIT STRING (SIZE(4)), |
| po8-r9 | BIT STRING (SIZE(8)), |

po16-r9 BIT STRING (SIZE(16)),
...

| | | |
|---|---|---|
| } | OPTIONAL | -- Need OP |

}
-- ASN1STOP

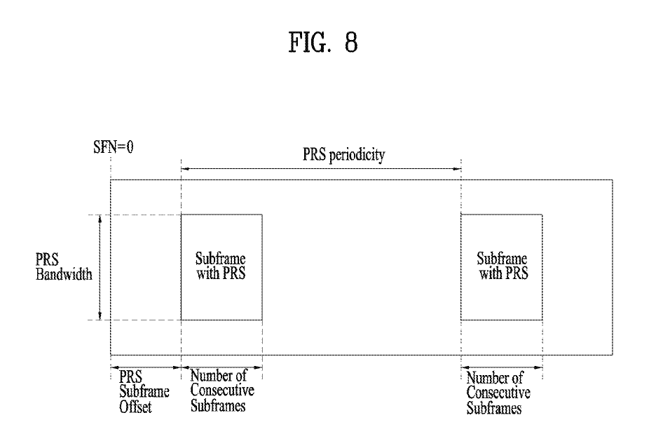

FIG. 8 illustrates a PRS transmission structure according to the above-described parameters of PRS-Info.

In FIG. 8, a PRS periodicity T_{PRS} and a PRS subframe offset Δ_{PRS} are determined according to a value of a PRS configuration index prs-ConfigurationIndex I_{PRS}. The PRS configuration index I_{PRS}, the PRS periodicity T_{PRS}, and the PRS subframe offset Δ_{PRS} are given by the following table.

TABLE 7

| PRS Configuration | PRS Periodicity T_{PRS} | PRS Subframe Offset [symbol] _{PRS} |
|---|---|---|
| Index I_{PRS} | (subframes) | (subframes) |
| 0~159 | 150 | I_{PRS} |
| 160~479 | 320 | I_{PRS}-160 |
| 480~1119 | 640 | I_{PRS}-480 |
| 1120~2399 | 1280 | I_{PRS}-1120 |

| | |
|---|---|
| 2400-4095 | Reserved |

The first subframe among N_{PRS} DL subframes with the PRS satisfies “10*n_{f}+floor(nₛ/2)−Δ_{PRS})mod T_{PRS}=0”. Herein, n_{f} is a radio frame number and nₛ is a slot number in a radio frame.

The location server (e.g. E-SMLC) may interact with an any eNB reachable from mobility management entities (MMEs) having signaling access to the location server in order to obtain location related information for supporting a DL positioning scheme. The location related information may include timing information for the eNB in relation to an absolute global navigation satellite system (GNSS) time or a timing of other eNB(s) and information about supported cells including PRS schedule. A signal between the location server and the eNB is transmitted through any MME with signaling access to the location server and to the eNB.

In addition to the DL positioning scheme in which a target UE calculates a measurement metric by measuring PRSs transmitted by eNBs, there is a UL positioning scheme in which eNBs measure a signal transmitted by the UE. The UL positioning scheme is based on an uplink time difference of arrival (UTDOA). To support UL positioning, the location server (e.g. E-SMLC) may interact a serving eNB of the UE in order to retrieve target UE configuration information. The configuration information includes information demanded by location measurement units (LMUs) in order to obtain UL time measurements. The LMUs correspond to eNBs that read a signal transmitted by the UE, for UL positioning. The location server informs the serving eNB that it is necessary for the UE to transmit an SRS (up to a maximum SRS bandwidth available for carrier frequency) for UL positioning. If requested resources are not available, the serving eNB may allocate other resources and report the allocated resources to the location server. If there are no usable resources, the serving eNB may inform the location server of this fact.

The location server may request that a plurality of LMUs perform UL time measurement and report the measurement result. In UL positioning, a UE location is estimated based on timing measurement of UL radio signals received by different LMUs together with knowledge of geographical coordinates of the different LMUs. A time required for a signal transmitted by the UE to reach an LMU is proportional to the length of a transmission path between the UE and the LMU. A set of LMUs measure a UTDOA by simultaneously sampling a UE signal.

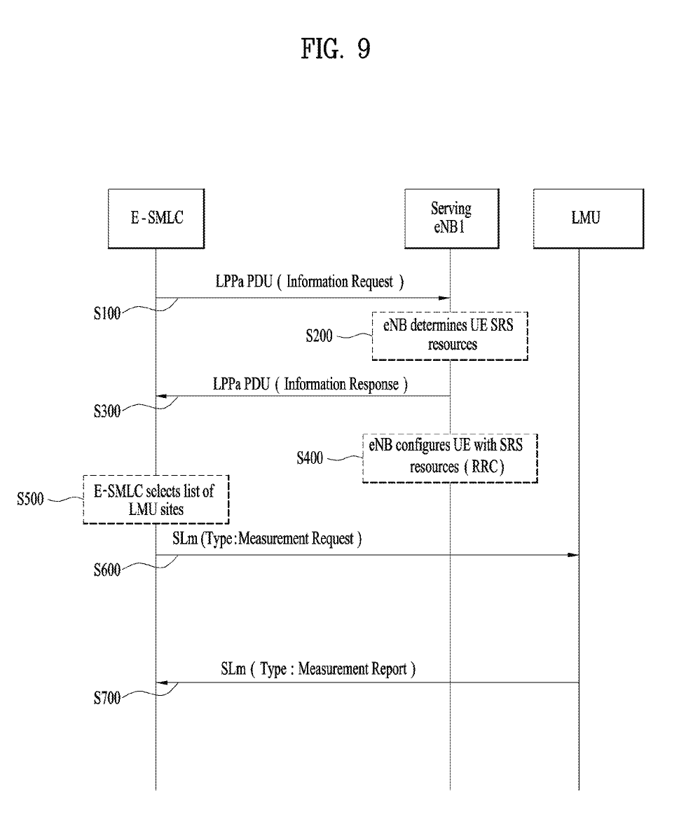

FIG. 9 illustrates an information request procedure for UL positioning.

The information request procedure for UL positioning is used by the location server (e.g. E-SMLC) to obtain a measurement result from the LMU. The location server uses the measurement result to calculate the location of the UE.

S100. The E-SMLC transmits an information request message indicating the need to invoke a periodic SRS for a target UE to a serving eNB of the target UE. An LTE positioning protocol annex (LPPa) protocol data unit (PDU) may be used to transmit the information request message. The E-SMLC may provide the number of SRS transmissions to the serving eNB. The decision of SRS transmissions to be performed and whether to consider the information request message depend entirely on eNB implementation.

S200 and S300. The serving eNB determines resources to be allocated to the target UE (S200) and transmits an information response to the E-SMLC (S300). The LPPa PDU may be used to transmit the information response. The information response may include parameters related to the allocated resources. The serving eNB (e.g. when available resources are absent) may determine to configure no resources for the UE and report an empty resource configuration to the E-SMLC.

S400. If the serving eNB determines that resources will be allocated in S200, the serving eNB allocates the resources to the target UE.

S500 and S600. The E-SMLC selects a set of LMUs to be used for UTDOA positioning (S500) and transmits a measurement request with an SRS configuration to each of the LMUs (through SLm) (S600). That is, the E-SMLC selects eNBs that are to participate in UTDOA positioning and transmits the measurement request to the eNBs. In this case, SLm indicates an SLm interface between the E-SMLC and the LMU, used for UL positioning.

S700. The LMUs transmit a UL measurement report to the E-SMLC.

For example, a UL relative time of arrival T_{UL-RTDOA} may be used for the UL measurement report. The UL relative time of arrival T_{UL-RTDOA} is the beginning of a subframe i containing an SRS received in LMU j, relative to a configurable reference time. A reference point for the UL relative time of arrival is an RX antenna connector of an LMU node when an LMU has a separate Rx antenna or shares the Rx antenna with an eNB and an eNB antenna connector when the LMU is integrated in the eNB.

In addition to the above-described OTDOA based positioning scheme and UTDOA based positioning scheme, there are other positioning schemes including an assisted global navigation satellite system (A-GNSS) positioning scheme, an enhanced cell-ID (E-CID) scheme, etc. and various location based services (e.g. advertisement, location tracking, emergency communication, etc.) may be provided by these positioning schemes.

The legacy positioning schemes are already supported by 3GPP UTRA and E-UTRA standards (e.g. 3GPP LTE release-9). However, recently, an evolved positioning scheme having higher accuracy has been demanded. In particular, an evolved positioning scheme for in-building positioning is needed. While the legacy positioning schemes are technology capable of being commonly applied to an outdoor/indoor environment, positioning accuracy by the legacy positioning schemes is not high. For example, according to the E-CID scheme, it is known that positioning accuracy is 150 m in a non-line of sight (NLOS) environment and 50 m in a light of sight (LOS) environment. In addition, even in the OTDOA scheme using a PRS, a positioning error may exceed 100 m due to an eNB synchronization error, a multipath propagation error, an RSTD measurement quantization error of the UE, and a timing offset estimation error, thereby limiting positioning accuracy. Therefore, there is a limit to apply the legacy positioning schemes to in-building positioning.

In consideration of such a problem, the present invention proposes the following new positioning schemes. In particular, the present invention proposes embodiments for performing location tracking by receiving, by other UEs, a UL signal transmitted by a neighbor UE in order to improve in-building positioning performance. If an eNB is located outdoors and UE(s) are located indoors, since a UE can more accurately receive signals transmitted by the UE(s) located indoors than a signal transmitted by the eNB, the embodiments of the present invention can be useful. It will be assumed in the embodiments of the present invention described hereinbelow that the location of a UE that transmits an RS is fixed or the location of the UE that transmits the RS is known to a network, an eNB, or a location server.

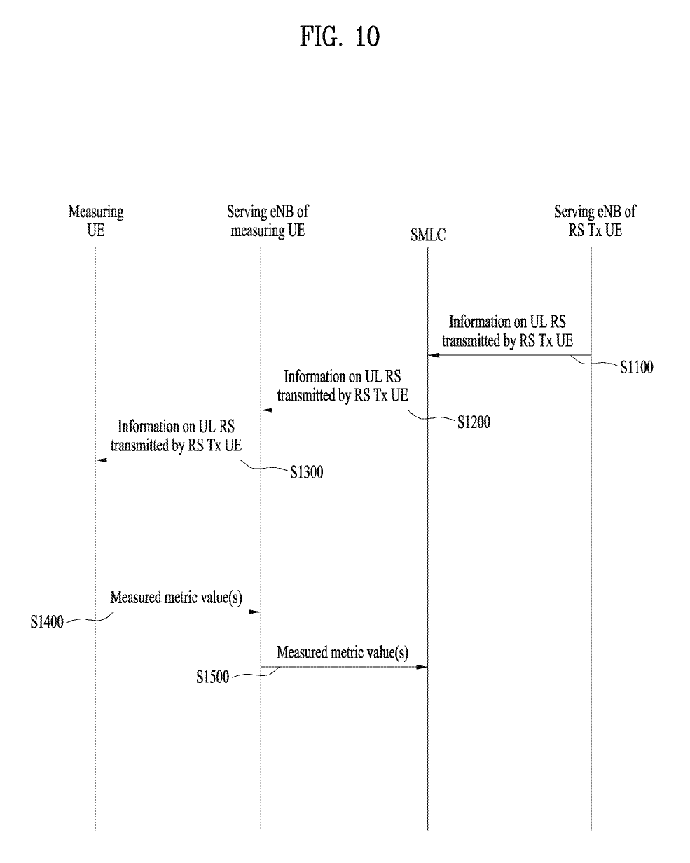

FIG. 10 illustrates a positioning procedure according to an embodiment of the present invention.

The present invention proposes that a UE receive a UL signal (e.g. SRS or a DM RS) transmitted by a neighbor UE and use the received UL signal for location measurement. That is, as opposed to an OTDOA based positioning scheme in which an eNB transmits a signal for location measurement and a target UE receives the signal for location measurement and an UTDOA based positioning scheme in which the target UE transmits the signal for location measurement and the eNB receives the signal for location measurement, in the embodiments of the present invention, the signal for location measurement is transmitted by a UE and the signal for location measurement is received by a UE. Hereinafter, the embodiments of the present invention will be described by referring to a UE that transmits an RS for location measurement as an RS Tx UE and a UE that receives the RS for location measurement and performs location measurement as a measurement UE. In addition, the embodiments of the present invention are described by referring to a location server, which is a physical or logical entity for managing positioning for a target device by providing assistance data to positioning units in order to obtain measurement and location information from one or more positioning units and aid in determining such measurement and location information, as an SMLC.

1. Measurement Metric

A measurement UE may receive a UL signal (e.g. SRS) transmitted by RS Tx UE(s) and obtain the following metric value(s). The measurement UE may report the obtained metric value(s) to an eNB connected thereto (e.g. an eNB operating/controlling a Pcell) (hereinafter, a serving eNB).

Option (a)

A difference between a ‘Tx timing’ for a serving cell of the measurement UE and a ‘timing at which a UL signal is received’ from an RS Tx UE may be used as a measurement metric.

Option (b)

A difference between an ‘Rx timing’ for the serving cell of the measurement UE and the ‘timing at which the UL signal is received’ from the RS Tx UE may be used as the measurement metric.

Option (c)

A difference between a ‘Tx/Rx timing of an eNB’ operating/controlling a serving cell of the measurement UE and the ‘timing at which the UL signal is received’ from the RS Tx UE may be used as the measurement metric.

Option (d)

A difference between a ‘reference timing configured by the eNB’ operating/controlling the serving cell of the measurement UE and the ‘timing at which the UL signal is received’ from the RS Tx UE may be used as the measurement metric.

Option (e)

A value of a ‘reception power of the UL signal’ received by the measurement UE from the RS Tx UE may be used as the measurement metric.

Option (f)

A difference between an ‘Rx timing’ of a UL signal transmitted by a reference UE and the ‘timing at which the UL signal is received’ from the RS Tx UE may be used as the measurement metric.

2. Configurations from an eNB of an RS Tx UE to an SMLC (S1100)

A serving eNB of the RS Tx UE informs an SMLC of information on a UL signal (e.g. SRS) transmitted by the RS Tx UE. The information on the UL signal may include, for example, an ID (a physical cell ID (PCI), a virtual cell ID, or a scrambling ID applied to the SRS), a ‘UE Rx-Tx time difference’ of the RS Tx UE, and/or a transmission power of the UL signal (e.g. SRS) of the RS Tx UE.

3. Configurations from the SMLC to an eNB of a Measurement UE (S1200)

The SMLC may inform a serving eNB of the measurement UE of the information on the UL signal (e.g. SRS) transmitted by the RS Tx UE. The information on the UL signal may include an ID (a PCI, a virtual cell ID, or a scrambling ID applied to the SRS), a ‘UE Rx-Tx time difference’ of the Rs Tx UE, an index of a reference UE (when Option (f) of the measurement metric is used), a reference timing (when Option (d) of the measurement metric is used), and/or a transmission power of the UL signal (e.g. SRS) of the RS Tx UE (when Option (e) of the measurement metric is used).

4. Configurations from the eNB of the Measurement UE to the Measurement UE (S1300)

The serving eNB of the measurement UE may inform the measurement UE of the information on the UL signal (e.g. SRS) transmitted by the RS Tx UE. The information on the UL signal may include, for example, an ID (a PCI, a virtual cell ID, or a scrambling ID applied to an SRS), a ‘UE Rx-Tx time difference’ of the RS Tx UE, a measurement UE list (IDs of UEs that are to perform measurement when there is a plurality of measurement UEs), an index of a reference UE (when Option (f) of the measurement metric is used), a reference timing (when Option (d) of the measurement metric is used), and/or a transmission power of the UL signal (e.g. SRS) of the RS Tx UE (when Option (e) of the measurement metric is used).

5. Reporting from the Measurement UE to the eNB of the Measurement UE (S1400)

The measurement UE reports measured metric values obtained using the information on the UL signal (e.g. SRS) received from the RS Tx UE to the serving eNB of the measurement UE. For example, the metric values measured according to Option (a), Option (b), . . . , or Option (f) described above, the ‘UE Rx-Tx time difference’ of the measurement UE, and/or the index of the reference UE may be reported to the serving eNB of the measurement UE.

6. Reporting from the eNB of the Measurement UE to the SMLC (S1500)

Upon receiving the measured metric values from the measurement UE, the eNB reports a result corresponding to the measured metric value to the SMLC. For example, the metric values measured according to Option (a), Option (b), . . . , or Option (f) described above, the ‘UE Rx-Tx time difference’ of the measurement UE, and/or the index of the reference UE may be reported to the SMLC by the serving eNB of the measurement UE.

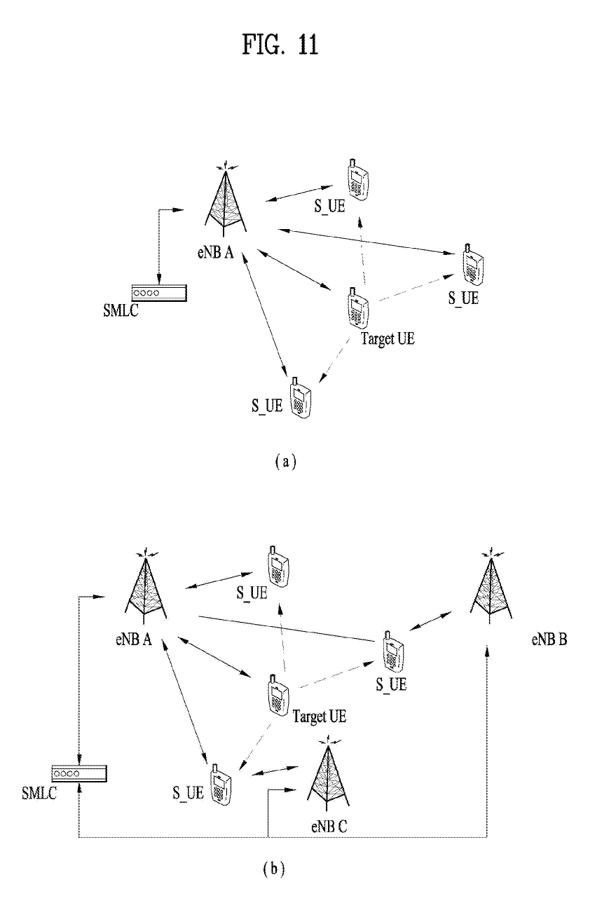

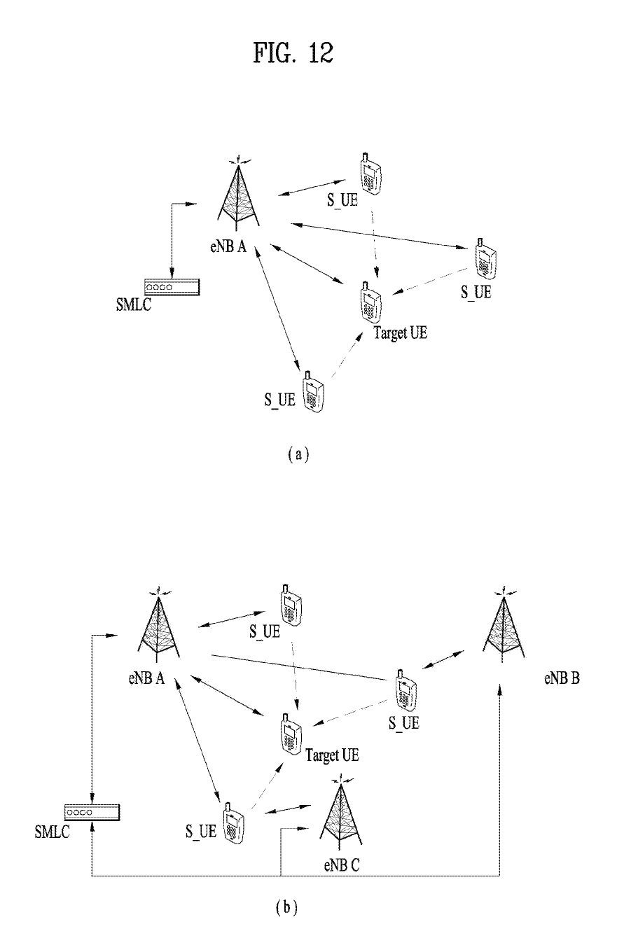

The present invention includes the following two measurement schemes. One is a scheme in which a target UE, which is a target of positioning, is a measurement UE and neighbor UE(s) of the target UE are RS Tx UE(s) and the other is a scheme in which the target UE is an RS Tx UE and neighbor UE(s) of the target UE are measurement UE(s). FIGS. 11 and 12 illustrate location measurement schemes according to the present invention. FIG. 11 illustrates the case in which a target UE is an RS Tx UE and neighbor UE(s) are measurement UE(s) that receive an RS received by the target UE and perform measurement and FIG. 12 illustrates the case in which neighbor UE(s) of a target UE are RS Tx UE(s) and the target UE is a measurement UE that receives an RS from the neighbor UE(s) and performs measurement.

For example, when a target UE about which it is desired to be aware of location information and static UEs (hereinafter, S_UEs) in the vicinity of the target UE are present, the neighbor S_UEs may receive a UL signal transmitted by the target UE as illustrated in FIG. 11. Each S_UE may obtain specific information about the received UL signal (e.g. a difference between a specific timing and a UL signal reception timing and/or a reception power of the UL signal) and report the obtained information to an eNB. eNBs connected to the respective S_UEs may transmit the corresponding information to an SMLC (or E-SMLC) and the SMLC may collect the information obtained by receiving the UL signal of the target UE by the S_UEs and estimate the location information of the target UE through the collected information. In this case, as illustrated in FIG. 11(a), all of the S_UEs that receive the UL signal of the target UE may be connected to an eNB to which the target UE is connected. That is, the target UE and the S_UE(s) participating in positioning of the target UE may have the same eNB as serving eNBs. Alternatively, as illustrated in FIG. 11(b), the S_UEs that receive the UL signal of the target UE may be connected to an eNB to which the target UE is connected or to other eNBs. In other words, the target UE and the S_UEs may have different eNBs as serving eNBs.

As another example, as illustrated in FIG. 12, a target UE may receive UL signals transmitted by neighbor S_UEs, obtain specific information about the UL signals transmitted by the respective S_UEs (e.g. a difference between a specific timing and a UL signal reception timing and/or a reception power of a UL signal), and report the obtained information to an eNB. The eNB connected to the target UE may transmit the corresponding information to an SMLC and the SMLC may collect information obtained by receiving the UL signals of the respective S_UEs by the target UE and estimate location information of the target UE through the collected information. As illustrated in FIG. 12(a), all of the S_UEs that transmit the UL signals may be connected to an eNB to which the target UE is connected. Alternatively, as illustrated in FIG. 12(b), the S_UEs that transmit the UL signals may be connected to an eNB to which the target UE is connected or to other eNBs.

To perform a scheme proposed in the present invention, a UE for performing measurement should be capable of receiving UL signals transmitted by neighbor UEs. To this end, it may be assumed in an FDD environment that the UE for performing measurement can receive the UL signals on a UL frequency. Alternatively, it may be assumed in a TDD environment that the UE can receive the UL signals transmitted in UL subframes. Alternatively, it may be assumed that the UE for performing measurement is a D2D UE so as to receive signals transmitted by neighbor (D2D) UEs.

To perform a scheme proposed in the present invention, an S_UE should be aware of location information thereof. Alternatively, an eNB or an SMLC connected to the S_UE should be aware of the location information of the S_UE. To this end, it may be assumed that S_UEs are fixed UEs. Such location information may be known to the S_UE or to the eNB or the SMLC connected to the S_UE. Alternatively, it may be assumed that S_UEs are UEs capable of estimating the locations thereof with a high probability. To enable the S_UE to estimate the location thereof with a high probability, the S_UE may be limited to a UE capable of receiving signals transmitted by a specific number (e.g. 3) or more of neighbor eNBs (or TPs) at received SNRs equal to or greater than a threshold value. Alternatively, the S_UE may be limited to a UE having a transmission signal that all of a specific number (e.g. 3) or more of neighbor eNBs can receive at a received SNR equal to or greater than the specific threshold value.

For convenience of description, in the present invention, the case in which a UL signal used for location estimation is an SRS is described. However, the present invention may include the case in which UL signals other than the SRS are used for location estimation.

A. Location Estimation Method 1

As illustrated in FIG. 11, neighbor S_UEs may receive an SRS transmitted by a target UE and obtain specific metric values using the UL signal transmitted by the target UE. The S_UEs may report obtained information to eNBs connected thereto (e.g. eNBs operating/controlling Pcells of the S_UEs).

<A-1. Measurement Metric>

The neighbor S_UEs may receive the UL signal (e.g. SRS) transmitted by the target UE and obtain the following metric values. Next, the S_UEs may report the obtained metric values to eNBs connected thereto (e.g. eNBs operating/controlling Pcells of the S_UEs).

Option (a)

A difference between a ‘Tx timing’ for a serving cell of an S_UE and a ‘timing at which the UL signal is received’ from the target UE may be used as a measurement metric.

Herein, the ‘Tx timing’ may mean a timing at which the S_UE starts (or ends) transmission of subframe n to the serving cell thereof when the UL signal (e.g. SRS) is received from the target UE in subframe n. In other words, a timing at which the S_UE starts (or ends) transmission of subframe n may be the Tx timing.

In addition, the ‘timing at which the UL signal is received’ may mean a timing at which reception of subframe n is started (or ended) when the UL signal (e.g. SRS) used for measurement is received in subframe n. In other words, when the target UE transmits the SRS in subframe n, a timing at which the S_UE starts (or ends) reception of subframe n transmitted by the target UE may be the timing at which the UL signal is received.

Herein, the serving cell may be a Pcell of the S_UE or a specific cell configured by a serving eNB of the S_UE. Alternatively, the serving cell may be a cell that transmits a configuration indicating that location measurement should be performed to the S_UE. In other words, the serving cell may be a cell carrying a location measurement request message to the S_UE.

Option (b)

A difference between an ‘Rx timing’ for the serving cell of the S_UE and the ‘timing at which the UL signal is received’ from the target UE may be used as the measurement metric.

Herein, the ‘Rx timing’ may mean a timing at which the S_UE starts (or ends) reception of subframe n on the serving cell thereof when the UL signal (e.g. SRS) is received from the target UE in subframe n. In other words, a timing at which the S_UE starts (or ends) reception of subframe n thereof may be the Rx timing.

In addition, the ‘timing at which the UL signal is received’ may mean a timing at which reception of subframe n is started (or ended) when the UL signal (e.g. SRS) used for measurement is received in subframe n. In other words, a timing at which the S_UE starts (ends) reception of subframe n from the target UE when the target UE transmits the SRS in subframe n may be the timing at which the UL signal is received.

Herein, the serving cell may be the Pcell of the S_UE or a specific cell configured by the serving eNB of the S_UE. Alternatively, the serving cell may be a cell that transmits a configuration indicating that location measurement should be performed to the S_UE.

Option (c)

A difference between a ‘Tx/Rx timing of an eNB’ operating/controlling the serving cell of the S_UE and the ‘timing at which the UL signal is received’ from the target UE may be used as the measurement metric.

Herein, the ‘Tx/Rx timing of an eNB’ may mean a timing at which the eNB operating/controlling the serving cell of the S_UE starts (or ends) transmission/reception of subframe n when the UL signal (e.g. SRS) is received from the target UE in subframe n. In this case, the S_UE may use a ‘UE Rx-Tx time difference’ thereof to calculate the ‘Tx/Rx timing of an eNB’. For example, the S_UE may assume that a value obtained by subtracting ½*‘S_UE Rx-Tx time difference’ from a timing at which the S_UE starts (or ends) reception of subframe n on the serving cell of thereof is the timing at which the eNB starts (ends) transmission/reception of subframe n. Alternatively, the S_UE may assume that a value obtained by adding ½*‘S_UE Rx′-Tx time difference’ to a timing at which the S_UE starts (or ends) transmission of subframe n to the serving cell thereof is the timing at which the eNB starts (ends) transmission/reception of subframe n.

In addition, the ‘timing at which the UL signal is received’ may mean a timing at which the S_UE starts (ends) reception of subframe n from the target UE when the UL signal (e.g. SRS) used for measurement is received in subframe n.

In this case, the serving cell may be the Pcell of the S_UE or a specific cell configured by the serving eNB of the S_UE. Alternatively, the serving cell may be a cell that transmits a configuration indicating that location measurement should be performed to the S_UE.

Option (d)

The S_UE may use a difference between a reference timing configured by the eNB operating/controlling the serving cell and the ‘timing at which the UL signal is received’ from the target UE may be used as the measurement metric.

To this end, the reference timing for measurement may be configured for the S_UE by the eNB.

The ‘timing at which the UL signal is received’ may mean a timing at which the S_UE starts (ends) reception of subframe n with the SRS transmitted by the target UE when the UL signal (e.g. SRS) used for measurement is received in subframe n.

In this case, the serving cell may be the Pcell of the S_UE or a specific cell configured by the serving eNB of the S_UE. Alternatively, the serving cell may be a cell that transmits a configuration for location measurement.

Option (e)

The S_UE may use a ‘reception power of the UL signal’ received from the target UE as the measurement metric.

Herein, the ‘reception power of the UL signal’ means a reception power of the UL signal (e.g. SRS) transmitted by the target UE and received by the S_UE.

<A-2. Configurations from an eNB of a Target UE to an SMLC>

The eNB operating/controlling the serving cell of the target UE may inform the SMLC of information regarding the UL signal (e.g. SRS) transmitted by the target UE. For example, the serving eNB of the target UE may report the following configurations to the SMLC. In this case, the serving cell may be a Pcell of the target UE.
PCI (or a virtual cell ID or a separate scrambling ID applied to the SRS)
UL EUTRA absolute radio-frequency channel number (UL-EARFCN)
UL cyclic prefix
UL system bandwidth of the cell
Cell-specific SRS bandwidth configuration srs-BandwidthConfig: refer to 3GPP TS 36.211 and 3GPP TS 36.331.
UE-specific bandwidth configuration srs-Bandwidth: refer to 3GPP 36.211 and 3GPP TS 36.331.
   The number of antenna ports for SRS transmission srs-AntennaPort: refer to 3GPP TS 36.211 and 3GPP TS 36.331.
Frequency domain position freqDomainPosition: refer to 3GPP TS 36.211 and 3GPP TS 36.331.
   SRS frequency hopping bandwidth configuration srs-HoppingBandwidth: refer to 3GPP TS 36.211 and 3GPP TS 36.331.
SRS-Cyclic shift cyclicShift: refer to 3GPP TS 36.211 and 3GPP TS 36.331.
Transmission comb TransmissionComb: refer to 3GPP TS 36.211 and 3GPP TS 36.331.
SRS configuration index srs-ConfigIndex: refer to 3GPP TS 36.211, 3GPP TS 36.213, and 3GPP TS 36.331.
MaxUpPt used for TDD only: refer to 3GPP TS 36.211 and 3GPP TS 36.331.
Group-hopping-enabled: refer to GPP TS 36.211.
deltaSS, parameter Δ_{SS}, included when SRS sequence hopping is used and not included otherwise: refer to Section 5.5.1.3 and Section 5.5.1.4 of 3GPP TS 36.213
System frame number (SFN) initialization time
‘UE Rx-Tx time difference’ of target UE

<A-3. Configurations from the SMLC to an eNB of an S_UE>

The SMLC may inform the eNB operating/controlling the serving cell of the S_UE of information regarding the UL signal (e.g. SRS) transmitted by the target UE. For example, the following configurations may be indicated to the eNB operating/controlling the serving cell of the S_UE. In this case, the serving cell may be a Pcell of the S_UE.
PCI (or a virtual cell ID or a separate scrambling ID applied to the SRS)
UL-EARFCN
UL cyclic prefix
UL system bandwidth of the cell
Cell-specific SRS bandwidth configuration srs-BandwidthConfig
UE-specific bandwidth configuration srs-Bandwidth
The number of antenna ports for SRS transmission srs-AntennaPort
Frequency domain position freqDomainPosition
SRS frequency hopping bandwidth configuration srs-HoppingBandwidth
SRS-Cyclic shift cyclicShift
Transmission comb TransmissionComb
SRS configuration index srs-ConfigIndex
MaxUpPt used for TDD only
Group-hopping-enabled
deltaSS, parameter Δ_{SS}, included when SRS sequence hopping is used and not included otherwise
‘UE Rx-Tx time difference’ of the target UE
List of S_UEs (IDs of S_UEs that are to perform measurement)
Reference timing (when Option (d) of the measurement metric is used)

<A-4. Configurations from the eNB of the S_UE to the S_UE>

The eNB operating/controlling the serving cell of the S_UE may inform the S_UE of information regarding the UL signal (e.g. SRS) transmitted by the target UE. For example, the eNB may inform the S_UE of the following configurations. In this case, the serving cell may be the Pcell of the S_UE.
PCI (or a virtual cell ID or a separate scrambling ID applied to an SRS)
UL-EARFCN
UL cyclic prefix
UL system bandwidth of the cell
Cell-specific SRS bandwidth configuration srs-BandwidthConfig
UE-specific bandwidth configuration srs-Bandwidth
The number of antenna ports for SRS transmission srs-AntennaPort
Frequency domain position freqDomainPosition
SRS frequency hopping bandwidth configuration srs-HoppingBandwidth
SRS-Cyclic shift cyclicShift
Transmission comb TransmissionComb
SRS configuration index srs-ConfigIndex
MaxUpPt used for TDD only
Group-hopping-enabled
deltaSS, parameter Δ_{SS}, included when SRS sequence hopping is used and not included otherwise
‘UE Rx-Tx time difference’ of the target UE
Reference timing (when Option (d) of the measurement metric is used)

<A-5. Reporting from an S_UE to an eNB of the S_UE>

The S_UE that has obtained given measurement metric values using the information about the UL signal (e.g. SRS) transmitted by the target UE reports a corresponding result to the eNB operating/controlling the serving cell thereof. In this case, values that the S_UE reports to the eNB may be as follows.
Measured metric values (Option (a), Option (b), . . . , or Option (e))
‘UE Rx-Tx time difference’ of the S_UE

<A-6. Reporting from the eNB of the S_UE to the SMLC>

The serving eNB of the S_UE that has received reporting of the measured metric values from the S_UE reports a corresponding result to the SMLC. In this case, values that the eNB operating/controlling the serving cell of the S_UE reports to the SMLC may be as follows. Herein, the serving cell may be the Pcell of the S_UE.
Measured metric values (Option (a), Option (b), . . . , or Option (e))
‘UE Rx-Tx time difference’ of the S_UE

B. Location Estimation Method 2

As illustrated in FIG. 12, the target UE may receive UL signals transmitted by neighbor S_UEs, obtain specific metric values, and report obtained information to an eNB connected thereto (e.g. an eNB operating/controlling a Pcell).

<B-1. Measurement Metric>

A target UE receives the UL signals (e.g. SRSs) transmitted by the neighbor S_UEs and obtains the following metric values. Next, the target UE may report the obtained metric values to the eNB connected thereto (e.g. the eNB operating/controlling the Pcell).

Option (a)

A difference between a ‘Tx timing’ for a serving cell of the target UE and a ‘timing at which the UL signal is received’ from an S_UE may be used as a measurement metric.

Herein, the Tx timing may mean a timing at which the target UE starts (or ends) transmission of subframe n to the serving cell thereof when the UL signal (e.g. SRS) is received from the S_UE in subframe n.

In addition, the ‘timing at which the UL signal is received’ may mean a timing at which reception of subframe n with the UL signal is started (or ended) when the UL signal (e.g. SRS) used for measurement is received in subframe n. Alternatively, in consideration of the fact that a timing at which each S_UE transmits the UL signal is slightly different, a value obtained by subtracting ½*‘S_UE Rx-Tx time difference’ from the ‘timing at which the UL signal is received’ from the S_UE may be used instead of the ‘timing at which the UL signal is received’.

Herein, the serving cell may be the Pcell of the target UE or a specific cell configured by the eNB. Alternatively, the serving cell may be a cell that transmits a configuration indicating that location measurement should be performed to the target UE.

Option (b)

A difference between an ‘Rx timing’ for the serving cell of the target UE and the ‘timing at which the UL signal is received’ from the S_UE may be used as the measurement metric.

Herein, the ‘Rx timing’ may mean a timing at which the target UE starts (or ends) reception of subframe n on the serving cell thereof when the UL signal (e.g. SRS) is received from the S_UE in subframe n.

In addition, the ‘timing at which the UL signal is received’ may mean a timing at which reception of subframe n with the SRS transmitted by the S_UE is started (or ended) when the UL signal (e.g. SRS) used for measurement is received in subframe n. Alternatively, in consideration of the fact that a timing at which each S_UE transmits the UL signal is slightly different, a value obtained by subtracting ½*‘S_UE Rx-Tx time difference’ from a timing at which the UL signal is received from the S_UE may be used instead of the ‘timing at which the UL signal is received’.

Herein, the serving cell may be the Pcell of the target UE or a specific cell configured by the eNB. Alternatively, the serving cell may be a cell that transmits a configuration indicating that location measurement should be performed to the target UE.

Option (c)

A difference between an ‘Rx timing’ for the serving cell of the target UE and the ‘timing at which the UL signal is received’ from the S_UE may be used as the measurement metric.

Herein, the ‘Rx timing’ may mean a timing at which the target UE starts (or ends) reception of subframe n on the serving cell thereof when the UL signal (e.g. SRS) is received from the S_UE in subframe n.

In addition, the ‘timing at which the UL signal is received’ may mean a timing at which reception of subframe n is started (or ended) when the UL signal (e.g. SRS) used for measurement is received in subframe n. Alternatively, in consideration of the fact that a timing at which each S_UE transmits the UL signal is slightly different, a value obtained by subtracting ½*‘S_UE Rx-Tx time difference’ from a timing at which the UL signal of the S_UE is received from the S_UE may be used instead of the ‘timing at which the UL signal is received’.

Herein, the serving cell may be a Pcell of the target UE or a specific cell configured by the eNB. Alternatively, the serving cell may be a cell that transmits a configuration indicating that location measurement should be performed to the target UE.

Option (d)

The target UE may use a difference between a reference timing configured by the eNB operating/controlling the serving cell and the ‘timing at which the UL signal is received’ from the S_UE may be used as the measurement metric.

To this end, the reference timing for measurement may be configured for the target UE by the eNB.

The ‘timing at which the UL signal is received’ may mean a timing at which reception of subframe n is started (or ended) when the UL signal (e.g. SRS) used for measurement is received in subframe n. Alternatively, in consideration of the fact that a timing at which each S_UE transmits the UL signal is slightly different, a value obtained by subtracting ½*‘S_UE Rx-Tx time difference’ from the ‘timing at which the UL signal is received’ from the S_UE may be used instead of the ‘timing at which the UL signal is received’.

Herein, the serving cell may be a Pcell of the S_UE or a specific cell configured by the eNB. Alternatively, the serving cell may be a cell that transmits a configuration for location measurement.

Option (e)

The target UE may use a ‘reception power of the UL signal’ received from the S_UE as the measurement metric.

Herein, the ‘reception power of the UL signal’ means a reception power of the UL signal (e.g. SRS) transmitted by the S_UE and received by the target UE.

Option (f)

A difference between an ‘Rx timing’ for a UL signal transmitted by a reference S_UE and the ‘timing at which the UL signal is received’ from the S_UE may be used as the measurement metric.

Herein, the reference S_UE may be configured for the target UE by the eNB operating/controlling the serving cell of the target UE or the target UE may randomly select the reference S_UE from among S_UEs.

The ‘Rx timing’ for the UL signal transmitted by the reference S_UE may mean a timing at which the target UE starts (or ends) reception of subframe n from the reference S_UE when the UL signal (e.g. SRS) is received from the S_UE in subframe n.

In addition, the ‘timing at which the UL signal is received’ may mean a timing at which reception of subframe n is started (or ended) when the UL signal (e.g. SRS) used for measurement is received in subframe n. Alternatively, in consideration of the fact that a timing at which each S_UE transmits the UL signal is slightly different, a value obtained by subtracting ½*‘S_UE Rx-Tx time difference’ from the ‘timing at which the UL signal is received’ from the S_UE may be used instead of the ‘timing at which the UL signal is received’.

Herein, the serving cell may be the Pcell of the target UE or a specific cell configured by the eNB. Alternatively, the serving cell may be a cell that transmits configuration indicating that location measurement should be performed to the target UE.

<B-2. Configurations from the eNB of the S_UE to the SMLC>

The eNB operating/controlling the serving cell of the S_UE may inform the SMLC of information about the UL signal (e.g. SRS) transmitted by the S_UE. For example, the eNB may report the following configurations to the SMLC. In this case, the serving cell may be a Pcell of the S_UE.
PCI (or a virtual cell ID or a separate scrambling ID applied to SRS)
UL-EARFCN
UL cyclic prefix
UL system bandwidth of the cell
Cell-specific SRS bandwidth configuration srs-BandwidthConfig
UE-specific bandwidth configuration srs-Bandwidth
The number of antenna ports for SRS transmission srs-AntennaPort
Frequency domain position freqDomainPosition
SRS frequency hopping bandwidth configuration srs-HoppingBandwidth
SRS-Cyclic shift cyclicShift
Transmission comb TransmissionComb
SRS configuration index srs-ConfigIndex
MaxUpPt used for TDD only
Group-hopping-enabled
deltaSS, parameter Δ_{SS}, included when SRS sequence hopping is used and not included otherwise
System frame number (SFN) initialization time
‘UE Rx-Tx time difference’ of the S_UE
Transmission power of the UL signal (e.g. SRS) of the S_UE (when Option (e) of the measurement metric is used)

<B-3. Configurations from the SMLC to the eNB of the Target UE>

The SMLC may inform the eNB operating/controlling the serving cell of the target UE of the information about the UL signal (e.g. SRS) transmitted by the S_UE. For example, the SMLC may inform the eNB operating/controlling the serving cell of the target UE of the following configurations. In this case, the serving cell may be the Pcell of the target UE. When S_UEs are configured to have different values, a configuration per S_UE may be provided to the eNB of the target UE.
PCI (or a virtual cell ID or a separate scrambling ID applied to SRS)
UL-EARFCN
UL cyclic prefix
UL system bandwidth of the cell
Cell-specific SRS bandwidth configuration srs-BandwidthConfig
UE-specific bandwidth configuration srs-Bandwidth
The number of antenna ports for SRS transmission srs-AntennaPort
Frequency domain position freqDomainPosition
SRS frequency hopping bandwidth configuration srs-HoppingBandwidth
SRS-Cyclic shift cyclicShift
Transmission comb TransmissionComb
SRS configuration index srs-ConfigIndex
MaxUpPt used for TDD only
Group-hopping-enabled
deltaSS, parameter Δ_{SS}, included when SRS sequence hopping is used and not included otherwise
‘UE Rx-Tx time difference’ of the S_UE
Index of the reference S_UE (when Option (f) of the measurement metric is used)
Reference timing (when Option (d) of the measurement metric is used)
Transmission power of the UL signal (e.g. SRS) of the S_UE (when Option (e) of the measurement metric is used)

<B-4. Configurations from the eNB of the Target UE to Target UE>

The eNB operating/controlling the serving cell of the target UE may inform the target UE of the information about the UL signal (e.g. SRS) transmitted by each S_UE. For example, the eNB may inform the target UE of the following configurations. In this case, the serving cell may be the Pcell of the target UE. When S_UEs are configured to have different values, a configuration per S_UE may be provided to the target UE.
PCI (or a virtual cell ID or a separate scrambling ID applied to SRS)
UL cyclic prefix
UL system bandwidth of the cell
Cell-specific SRS bandwidth configuration srs-BandwidthConfig
UE-specific bandwidth configuration srs-Bandwidth
The number of antenna ports for SRS transmission srs-AntennaPort
Frequency domain position freqDomainPosition
SRS frequency hopping bandwidth configuration srs-HoppingBandwidth
SRS-Cyclic shift cyclicShift
Transmission comb TransmissionComb
SRS configuration index srs-ConfigIndex
MaxUpPt used for TDD only
Group-hopping-enabled
deltaSS, parameter Δ_{SS}, included when SRS sequence hopping is used and not included otherwise
‘UE Rx-Tx time difference’ of the S_UE
Index of the reference S_UE (when Option (f) of the measurement metric is used)
Reference timing (when Option (d) of the measurement metric is used)
Transmission power of the UL signal (e.g. SRS) of the S_UE (when Option (e) of the measurement metric is used)

<B-5. Reporting from the Target UE to the eNB of the Target UE>

The target UE obtains given measurement metric values per S_UE using the information about the UL signal (e.g. SRS) transmitted by the S_UE and reports a corresponding result to the eNB operating/controlling the serving cell thereof. In this case, values that the target UE reports to the eNB may be as follows. In this case, the serving cell may be the Pcell of the target UE. Characteristically, if S_UEs are configured to have different values, a corresponding value per S_UE may be reported to the eNB of the target UE.
Measured metric values (Option (a), Option (b), . . . , or Option (f))
‘UE Rx-Tx time difference’ of the target UE
Index of the reference S_UE (when Option (f) of the measurement metric is used)

<B-6. Reporting from the eNB of the Target UE to the SMLC>

Upon receiving reporting of the measured metric values from the target UE, the eNB reports a corresponding result to the SMLC. Values that the eNB operating/controlling the serving cell of the target UE reports to the SMLC may be as follows. Herein, the serving cell may be the Pcell of the target UE. if S_UEs are configured to have different values, a corresponding value per S_UE may be reported to the SMLC.
Measured metric values (Option (a), Option (b), . . . , or Option (f))
‘UE Rx-Tx time difference’ of the target UE
Index of the reference S_UE (when Option (f) of the measurement metric is used)

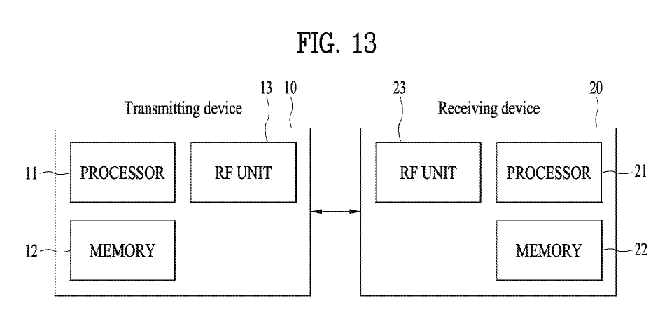

FIG. 13 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

In the embodiments of the present invention, a processor, an RF unit, and a memory included in an SMLC are referred to as an SMLC processor, an SMLC RF unit, and an SMLC memory, respectively.

A processor included in a serving eNB of an RS Tx UE may control an RF unit included in the serving eNB of the RS Tx UE to transmit configuration information about a UL signal for measurement transmitted by the RS Tx UE to the SMLC. The processor included in the serving eNB of the RS Tx UE may control an RF unit included in the serving eNB of the RS Tx UE to transmit the configuration information to the RS Tx UE. The processor of the RS Tx UE may control the RF unit of the RS Tx UE to transmit the UL signal (e.g. SRS) for supporting positioning according to the information about the UL signal.

The SMLC processor may provide the configuration information about the UL signal transmitted by the RS Tx UE to an eNB of a measurement UE. For example, the SMLC processor may control an SMLC RF unit to transmit the configuration information about the UL signal.

A processor of the measurement UE may control an RF unit of the measurement UE to receive the configuration information about the UL signal to be transmitted by the RS Tx UE from the serving eNB. The processor of the measurement UE may control the RF unit of the measurement UE to receive the UL signal transmitted by the RS Tx UE for measurement, based on the configuration information about the UL signal. The processor of the measurement UE may be configured to a measure a metric value according to Option (a) to Option (f), based on the configuration information about the UL signal. The processor of the measurement UE may control the RF unit of the measurement UE to transmit the measured metric value and/or a ‘UE Rx-Tx time difference’ of the measurement UE to the serving eNB.

The processor included in the serving eNB of the measurement UE may control the RF unit included in the serving eNB of the measurement UE to transmit the measured metric value and/or the ‘UE Rx-Tx time difference’ of the measurement UE to the SMLC.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, a UE, or other devices in a wireless communication system.

1. A method of performing measurement for positioning support for a specific user equipment (hereinafter, a target UE) by a user equipment (hereinafter, a measurement UE), the method comprising:
receiving configuration information about an uplink reference signal for positioning;
receiving the uplink reference signal based on the configuration information; and
transmitting information about a metric value measured based on the uplink reference signal and a reception-transmission time difference of the measurement UE,
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

2. The method according to claim 1,
wherein the information about the measured metric value includes at least a difference between a transmission timing for a serving cell of the measurement UE and a timing at which the measurement UE receives the uplink reference signal, a difference between a reception timing for the serving cell of the measurement UE and the timing at which the measurement UE receives the uplink reference signal, a difference between a transmission or reception timing of a serving base station of the measurement UE and a timing at which the uplink reference signal is transmitted by or received from the reference signal transmission UE, a difference between a reference timing configured by the serving base station of the measurement UE and the timing at which the uplink reference signal is received from the reference signal transmission UE, a difference between a reception timing of the uplink signal transmitted by the reference UE and the timing at which the uplink reference signal is received from the reference signal transmission UE, or a reception power of the uplink reference signal transmitted by the reference signal transmission UE and received by the measurement UE.

3. The method according to claim 1,
wherein the target UE is the measurement UE.

4. The method according to claim 1,
wherein the target UE is the reference signal transmission UE.

5. A user equipment (hereinafter, a measurement UE) for performing measurement for positioning support for a specific user equipment (hereinafter, a target UE), the measurement UE comprising,
a radio frequency (RF) unit configured to transmit or receive a signal and a processor configured to control the RF unit,
wherein the processor is configured to:
control the RF unit to receive configuration information about an uplink reference signal for positioning;
control the RF unit to receive the uplink reference signal based on the configuration information; and
control the RF unit to transmit information about a metric value measured based on the uplink reference signal and a reception-transmission time difference of the measurement UE, and
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

6. The measurement UE according to claim 5,
wherein the information about the measured metric value includes at least a difference between a transmission timing for a serving cell of the measurement UE and a timing at which the measurement UE receives the uplink reference signal, a difference between a reception timing for the serving cell of the measurement UE and the timing at which the measurement UE receives the uplink reference signal, a difference between a transmission or reception timing of a serving base station of the measurement UE and a timing at which the uplink reference signal is transmitted by or received from the reference signal transmission UE, a difference between a reference timing configured by the serving base station of the measurement UE and the timing at which the uplink reference signal is received from the reference signal transmission UE, a difference between a reception timing of the uplink signal transmitted by the reference UE and the timing at which the uplink reference signal is received from the reference signal transmission UE, or a reception power of the uplink reference signal transmitted by the reference signal transmission UE and received by the measurement UE.

7. The measurement UE according to claim 5,
wherein the target UE is the measurement UE.

8. The measurement UE according to claim 5,
wherein the target UE is the reference signal transmission UE.

9. A method of supporting positioning for a specific user equipment (hereinafter, a target UE) by a location server, the method comprising:
transmitting configuration information about an uplink reference signal for positioning to a serving base station of a user equipment for performing measurement (hereinafter, a measurement UE); and
receiving information about a metric value measured based on the uplink reference signal and a reception-transmission time difference of the measurement UE from the serving base station of the measurement UE,
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by the serving base station of the measurement UE or by the measurement UE, a reference timing, or a transmission power of the reference signal transmitted by the reference signal transmission UE.

10. A location server for supporting positioning for a specific user equipment (hereinafter, a target UE), the location server comprising,
a radio frequency (RF) unit configured to transmit or receive a signal and a processor configured to control the RF unit,
wherein the processor is configured to:
control the RF unit to transmit configuration information about an uplink reference signal for positioning to a serving base station of a user equipment for performing measurement (hereinafter, a measurement UE); and
control the RF unit to receive information about a metric value measured based on the uplink reference signal and a reception-transmission time difference of the measurement UE from the serving base station of the measurement UE, and
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by the serving base station of the measurement UE or by the measurement UE, a reference timing, or a transmission power of the reference signal transmitted by the reference signal transmission UE.

11. A method of supporting positioning for a specific user equipment (hereinafter, a target UE) by a base station, the method comprising:
transmitting configuration information about an uplink reference signal for positioning to a user equipment for performing measurement (hereinafter, a measurement UE); and
receiving information about a metric value measured based on the uplink reference signal and a reception-transmission time difference of the measurement UE from the measurement UE,
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.

12. A base station for supporting positioning for a specific user equipment (hereinafter, a target UE), the base station comprising,
a radio frequency (RF) unit configured to transmit or receive a signal and a processor configured to control the RF unit,
wherein the processor is configured to:
control the RF unit to transmit configuration information about an uplink reference signal for positioning to a user equipment for performing measurement (hereinafter, a measurement UE); and
control the RF unit to receive information about a metric value measured based on the uplink reference signal and a reception-transmission time difference of the measurement UE from the measurement UE, and
wherein the configuration information includes at least a cell identifier (ID) or a scrambling ID, applied to the uplink reference signal, a reception-transmission time difference of a UE transmitting the uplink reference signal (hereinafter, a reference signal transmission UE), an index of a UE configured as a reference UE by a serving base station of the measurement UE or by the measurement UE, a reference timing, or a transmission power of the reference signal transmitted by the reference signal transmission UE.
